(19) United States
(12) Patent Application Publication
(10) Pub. No.: US 2005/0235332 A1
(43) Pub. Date: Oct. 20, 2005

(54) Interactive icon management

(76) Inventors: Azita M. Manson, San Jose, CA (US); Ken Morse, Duluth, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/825,699

(22) Filed: Apr. 16, 2004

(51) Int. Cl. H04N 7/173; H04N 5/445

(52) U.S. Cl. 725/110; 725/40

(57) ABSTRACT

A method for providing a television presentation enhancement includes receiving from a remote location trigger attribute data identifying at least one display attribute of an interactive icon, responsive to receiving the trigger attribute data, causing an interactive icon having the at least one attribute identified by the trigger attribute data to be displayed via a display device, receiving user input selecting the interactive icon, and responsive to receiving the user input, providing a television presentation enhancement. Systems and other methods are also disclosed.

### FIELD OF THE INVENTION

This invention relates in general to television systems, and more particularly, to the field of television enhancement triggers.

### DESCRIPTION OF THE RELATED ART

As the number of television services increases, it is becoming increasingly important for television service providers to distinguish their services by providing viewers with more options and/or features that will make their viewing experience more entertaining. In addition, many viewers today are interested in knowing more about the video presentation that they are watching but simply do not have enough free time to locate and read such information. One approach for satisfying user demand for additional information is through the use of triggers, which are real-time events used to provide enhanced content in connection with a television presentation. For example, when a set-top terminal (STT) receives a trigger, the STT may cause a phrase (e.g., “find out more”) identified by the trigger to be displayed via a television that is coupled to the STT. The television viewer may select the phrase in order to view content that is retrieved using a URL identified by the trigger. Commonly used trigger systems (e.g., a trigger system defined by ATVEF (Advanced Television Enhancement Forum)) have limited features and do not accommodate effective use of interactive icons. Therefore there exists a need for systems and methods for implementing and/or managing interactive icons.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram depicting a non-limiting example of a subscriber television system in accordance with one embodiment of the invention.

FIG. 2 is a simplified block diagram illustrating selected components of a set-top terminal (STT) according to one embodiment of the invention.

FIG. 3 is a flow chart illustrating a method according to an embodiment of the invention.

FIG. 4 is a flow chart illustrating a method according to another embodiment of the invention.

FIG. 5 is a flow chart illustrating a method according to a further embodiment of the invention.

### DETAILED DESCRIPTION OF THE PREFERRED EMBODIMENTS

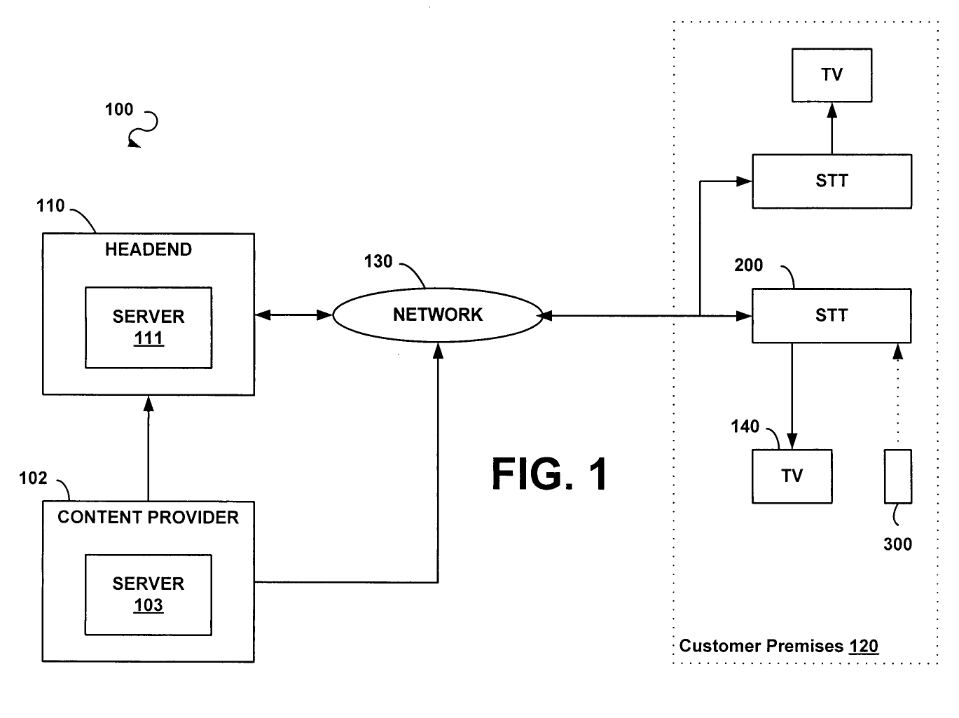

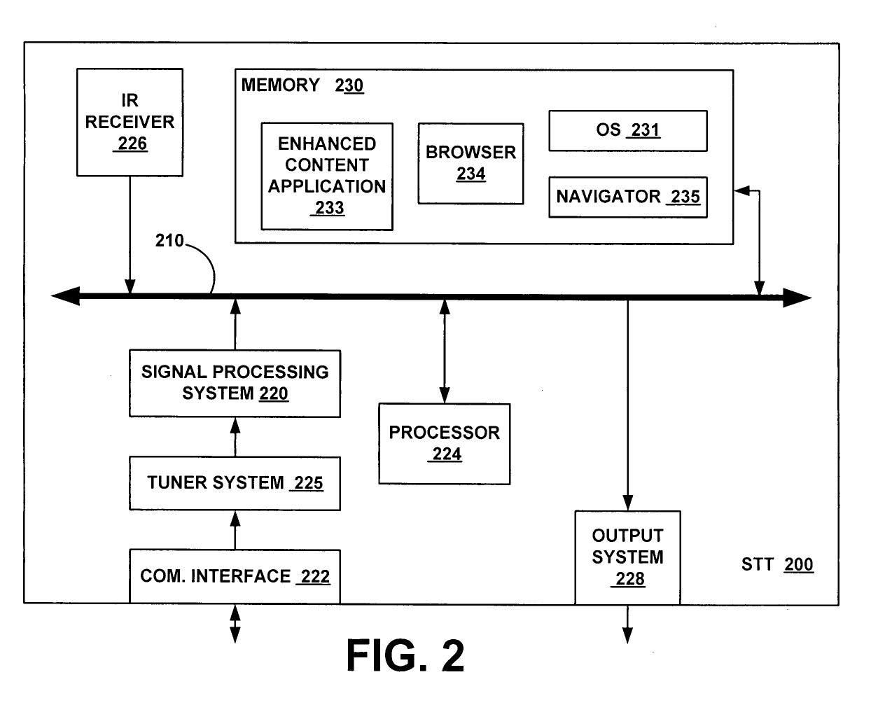

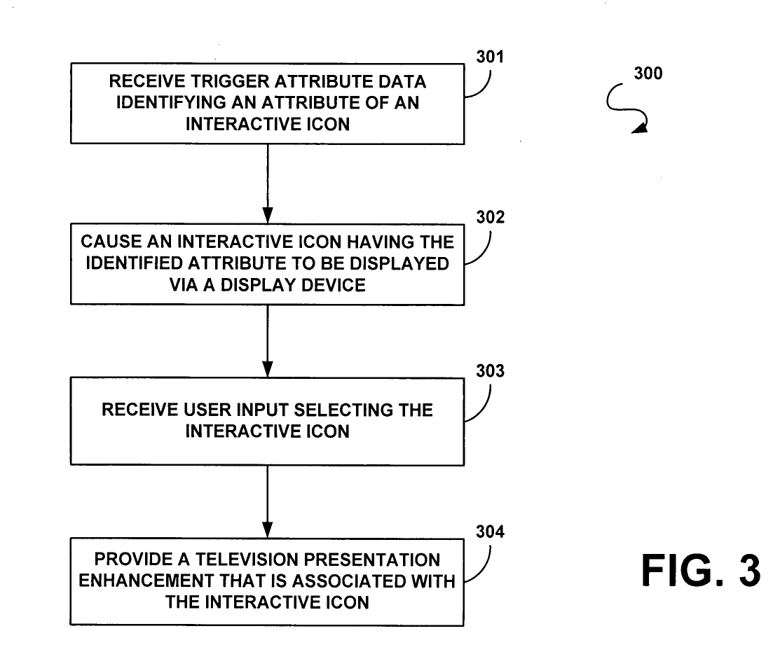

In one embodiment of the invention, a set-top terminal (STT) receives trigger attribute data identifying an icon attribute, and in response to receiving the trigger attribute data, causes an interactive icon having the icon attribute to be displayed via a display device. In one embodiment, the use of interactive icons is desirable since users can quickly recognize certain icons without having to read accompanying instructions. Another advantage in one embodiment of using interactive icons is that even if an icon is not selected by a user, the icon can still serve the effect of promoting a sponsor's logo. The trigger attribute data may be received from a headend, a content provider (e.g., a television station), or another STT. This and other embodiments are described in more detail below in reference to the five accompanying figures: FIG. 1 provides an example of a subscriber television system in which interactive icons may be implemented; FIG. 2 provides an example of a set-top terminal that may be used to implement interactive icons; and FIGS. 3-5 provide examples of methods for implementing interactive icons. Note, however, that the invention may be embodied in many different forms and should not be construed as limited to the embodiments set forth herein. Furthermore, all examples given herein are intended to be non-limiting, and are provided in order to help clarify the description of the invention.

Reference is now made to FIG. 1, which is a block diagram depicting a non-limiting example of a subscriber television system (STS) 100 in accordance with one embodiment of the invention. In this example, the STS 100 includes a headend 110 and an STT 200 that are coupled via a communication network (CN) 130. The CN 130 may be, for example, a hybrid fiber coax (HFC) network, a satellite communications network, a public switched telephone network (PSTN), or the Internet, among others. The STT 200 is typically situated at a customer premises 120, and may be a stand-alone unit or integrated into another device such as, for example, a television (TV) 140.

The customer premises 120, which may be a user's residence or place of business, may contain a single STT 200 or a plurality of STTs 200. If the customer premises 120 includes a plurality of STTs 200, then such STTs 200 may be configured to transmit data to each other. For example, a first STT 200 may be configured to transmit trigger attribute data to a second STT 200. The second STT 200 may then cause an interactive icon having an attribute identified by the trigger attribute data received from the first STT 200 to be displayed via a display device.

The STT 200 receives signals (video, audio and/or other data) from the headend 110 through the CN 130. The STT 200 may also use the CN 130 to provide upstream messages to the headend 110. A remote control device 150 may be used to provide user input to the STT 200. The remote control device 150 preferably provides user input via infra-red (IR) signals. However, the remote control device 150 may alternatively provide user input via other types of signals, such as, for example, wireless radio frequency (RF) signals. Other input devices (e.g., a keyboard or a mouse) may additionally or alternatively be used to provide user input.

A content provider 102 may include one or more servers 103 for providing the headend 110 and/or the STT 200 with video, audio, and other data (e.g., trigger attribute data). The headend 110 may include one or more servers 111 for providing video, audio, and other data (e.g., trigger attribute data) to the STT 200 via the CN 130. The server 111 may for example, provide the STT 200 with data received by the headend 110 from the content provider 102. The headend 110 and the STT 200 cooperate to provide a user with television services via the TV 140. The television services may include, for example, broadcast television services, video-on-demand (VOD) services, and/or pay-per-view (PPV) services, among others. Each television service typically corresponds to a television station (e.g., CNN) and is identified by a television channel number (e.g., channel 46).

FIG. 2 is a simplified block diagram illustrating selected components of an STT 200 according to one embodiment of the invention, among others. The STT 200 includes a local interface 210 that is used to transfer data among STT 200 components. The local interface 210 may include, for example, one or more buses or other wired and/or wireless connections. As shown in FIG. 2, the STT 200 includes at least one processor 224 and memory system 230, among other components.

The processor 224 is a hardware device for executing software, particularly that stored in memory system 230. The processor 224 can be a custom-made or a commercially available processor for executing software instructions. When the STT is in operation, the processor 224 is configured to execute software stored within the memory system 230, to communicate data to and from the memory system 230, and to generally control operations of the STT 200 pursuant to the software.

The memory system 230 may include any one or combination of volatile memory elements (e.g., random access memory (RAM), dynamic RAM (DRAM), static RAM (SRAM), synchronous DRAM (SDRAM), magnetic RAM (MRAM), etc.) and nonvolatile memory elements (e.g., read only memory (ROM), hard drive, tape, compact disk ROM (CD-ROM), etc.). Moreover, the memory system 230 may incorporate electronic, magnetic, optical, and/or other types of storage media. Note that the memory system 230 can have a distributed architecture, where various memory components are situated remotely from one another, but can be accessed by the processor 224.

The tuner system 225 includes, in one implementation, an out-of-band tuner for receiving out-of-band signals that were modulated using quadrature phase shift keying (QPSK), and one or more in-band quadrature amplitude modulation (QAM)/analog tuners for receiving analog and digital television services. The signal processing system 220 may be capable of demodulating, demultiplexing, and decoding signals that are tuned to by the tuner system 225. Although shown as one module, the signal processing system 220 may comprise multiple modules that are located in different parts of the STT 200.

The STT 200 also includes an IR receiver 226 which detects IR signals that encode remote control commands requesting television services or STT functionality. Remote control commands that are detected by the IR receiver 226 may be forwarded to the navigator application 235, which routes the commands to respective software applications.

The output system 228 is used to perform analog-to-digital conversion on television service data that are to be output to the TV 140. The output system 228 may provide the TV 140 with signals that are in, for example, NTSC (National Television Standard Committee) format. In an alternative embodiment, if the TV 140 is a digital television (e.g., an HDTV), then the output system 228 may include an MPEG (Motion Picture Experts Group) encoder for encoding television service data in an MPEG-2 format.

Software residing in memory system 230 may include one or more separate programs, each of which comprises instructions for implementing logical functions. In the example of FIG. 2, the software in the memory system 230 includes an operating system (OS) 231, an enhanced content application 233, a navigator 235, and a browser 234. The OS 231 controls the execution of other software and provides management and control services including, for example, scheduling, input-output control, file and data management, memory management, and communication control, among others. The navigator 235 is used to route user input commands to respective software applications that have registered with the navigator 235 to receive the commands. The browser 234 may be used to download icon images and/or other enhanced content from any local or remote server via, for example, a local area network (LAN), a wide area network (WAN), or the Internet.

Note that the STT 200 preferably includes additional software applications that are not shown in FIG. 2 in order to simplify the description of the STT 200. Other software applications that may be included in the STT 200 include applications that are programmed to provide television functionality such as, for example, an interactive program guide (IPG), video-on-demand (VOD) presentations, and/or pay-per-view (PPV) presentations.

The enhanced content application (ECA) 233 is used to help implement triggers that are received from a remote location, such as, for example, the headend 110 or the content provider 102 (FIG. 1). Triggers are real-time events that are used to provide enhanced content in connection with a television presentation. The ECA 233 may use trigger arrival as a signal to notify users of enhanced content availability. The ECA 233 may also be configured to allow users to turn on or off enhanced TV content.

According to one embodiment, a trigger identifies a source (e.g., a uniform resource locator (URL)) from which the enhanced content may be retrieved, and may optionally include a name, an expiration date, and/or a script. Triggers that include a “name” attribute may be used to initiate an enhancement either automatically, or with user confirmation. The initial top-level page for an enhancement may be indicated by the URL in the trigger. Triggers that do not include a “name” attribute are not intended to initiate an enhancement, but are preferably processed as events which affect (e.g., through the “script” attribute) enhancements that are currently active. If the trigger URL matches the current top-level page, and the expiration has not been reached, then the script is executed on that page. When testing for a match, parameters and fragment identifiers (i.e. characters in the URL including and following the first “?” or “#” character) in a URL may be ignored.

As a non-limiting example, triggers that comply with an ATVEF (Advanced Television Enhancement Forum) standard are text-based and begin with ASCII ‘<’. Other values for the first byte are reserved. Receivers may be configured to ignore any trigger that does not begin with the ‘<’ in the first byte. The general format for ATVEF compliant triggers includes a URL followed by zero or more attribute/value pairs and an optional checksum:

<url> [attr₁:val₁][attr₂:val₂] . . . [attrₙ:valₙ][checksum]

The URL is enclosed in angle brackets (e.g. <http://abc.com/ad.html>). Although any URL can be sent in this syntax, ATVEF content level 1 only requires support for http: and lid: URL schemes. The optional checksum may be placed at the end of a trigger, and is provided to detect data corruption. The following attribute/value pairs are defined by an ATVEF standard:

1) The ‘name’ attribute provides a readable text description (e.g. [name: Find Out More]). The string is any string of characters between 0x20 and 0x7e except square brackets (0x5b and 0x5d) and angle brackets (0x3c and 0x3e). The name attribute can be abbreviated as the single letter “n” (e.g. [n: Find Out More]).

2) The ‘expires’ attribute provides an expiration date, after which the link is no longer valid (e.g. [expires:19971223]). The time conforms to the ISO-8601 standard, except that it is assumed to be Greenwich Mean Time unless the time zone is specified. A recommended usage is the form yyyymmddThhmmss, where the capital letter “T” separates the date from the time. It is possible to shorten the time string by reducing the resolution. For example yyyymmddthhmm (no seconds specified) is valid, as is simply yyyymmdd (no time specified at all). When no time is specified, expiration is at the beginning of the specified day. The expires attribute can be abbreviated as the single letter “e” (e.g [e:19971223]).

3) The ‘script’ attribute provides a script fragment to execute within the context of the page containing the trigger receiver object (e.g. [script:shownews( )]). The script attribute can be abbreviated as the single letter “s” (e.g. [s:shownews( )]). An example of a script attribute used to navigate a frame within a page to a new URL: [script:frame1.src=“http://atv.com/f1”].

Using the above description, the following are examples of valid trigger strings:

<http://abc.com/ad.html>
<http://abc.com/ad.html>[name:Find out More!]
<lid://abc.com/ad.html>[n:Find out More!]
<lid://abc.com/ad.html>[n:Fun!][e:19991231T115959]
[s:frame1.src=“http://atv.com/frame1”]

According to one embodiment, a trigger may also include one or more of the following attribute/value pairs that are not defined by an ATVEF standard:

1) An ‘icon’ attribute identifying a source for an interactive icon image that is to be displayed via the television. As a non-limiting example, among others, the icon attribute may be in the form of [icon:source]. The source for an interactive icon image may be, for example, a remote server, a local server, or a local storage device. As a non-limiting example, if the source for an interactive icon image is a server that is connected to the internet, then such source may be identified as follows [icon: icon:http://abc.com/ad/icon.html]. Note that various other protocols may be used to retrieve an interactive icon image including, but not limited to, hyper text transfer protocol secure (https), file transfer protocol (ftp), trivial file transfer protocol (tftp), broadcast file system (bfs), digital storage media command and control (DSM-CC) object carousel, among others.

2) A ‘display-location’ attribute identifying a display location for an interactive icon. As a non-limiting example, among others, the display-location attribute may be in the form of [display-location: location]. The location may be specified in terms of the distance (e.g., in number of pixels) that the center of the icon is located relative to the bottom edge and right edge of the display screen. For example the attribute [display-location: B300R300] may be used to indicate that icon is to be centered at a screen location that is 300 pixels from the bottom edge of the screen and 300 pixels from the right edge of the screen.

3) A ‘duration’ attribute identifying a display time window during which an interactive icon may be displayed. As a non-limiting example, among others, the duration attribute may be in the form of [duration: duration]. The duration may be specified in the form of HhhMmmSss, where hh are digits that represent the number of hours, mm are digits that represent the number of minutes, and ss are digits that represent the number of seconds. Therefore, one example of a duration attribute may be [duration: H00M05S00]. The duration attribute may also be abbreviated to include fewer time indicators. For example, a duration attribute may be [duration:M05].

4) A ‘display-time’ attribute identifying a continuous length of time that an icon is to be displayed (e.g., within a pre-determined time window). As a non-limiting example, among others, display-time attribute may be in the form of [display-time: display time]. The display time may be specified, for example, in the form of HhhMmmSss, as discussed above.

5) A ‘sleep-time’ attribute identifying a duration for not displaying an interactive icon (e.g., after the interactive icon has been displayed). As a non-limiting example, among others, sleep-time attribute may be in the form of [sleep-time: duration]. The duration may be specified, for example, in the form of HhhMmmSss, as discussed above. When the sleep-time attribute is used in conjunction with the display-time attribute, the corresponding icon is displayed intermittently for display durations that are individually equal to the duration specified by the display-time attribute. Furthermore, the display durations would be separated by non-display durations that are individually equal to the duration specified by the sleep-time attribute.

According to one possible implementation, if a received trigger does not include one or more predetermined attribute/value pairs, then corresponding default values that are stored in the STT 200 may be used instead of the missing values. For example, if the received trigger does not identify a display location for the icon, then the icon may be displayed at a default location identified by a default value stored in the STT 200.

The following is a non-limiting example, among others, of a trigger, according to one embodiment of the invention:

<http://abc.com/ad.html>[icon:http://abc.com/ad/icon.html][display-
location: B300R300][duration: H01][display-time: M01][sleep-time: M05]

In this example, icon data may be retrieved from the Internet using the URL http://abc.com/ad/icon.html, and may be used to display an icon that is centered at a screen location that is 300 pixels from the bottom edge of the screen and 300 pixels from the right edge of the screen. The icon may be displayed during a time period that expires one hour from the time that the trigger is received, as specified in the attribute [duration: H01]. Furthermore, the icon is displayed for one-minute periods, as specified in the attribute [display-time: MO 1]. These one-minute display periods are separated by non-display periods that have five-minute durations, as specified by the attribute [sleep-time: M05]. Therefore, the icon will be displayed for ten one-minute periods that are separated by ten five-minute periods of non-display, after which the one hour duration specified by the attribute [duration: H01] expires. When a user selects the displayed icon (e.g., using the remote control device 300 (FIG. 1)), then the STT 200 retrieves enhanced content that is located at the URL http://abc.com/ad.html, and outputs the enhanced content to the TV 140 (FIG. 1).

FIG. 3 is a flow chart depicting a method 300 according to one embodiment of the present invention. In step 301, the STT 200 receives trigger attribute data identifying one or more attributes of an interactive icon. The trigger attribute data may, for example, be received from a headend, a content provider 102, or another STT 200. As a non-limiting example, among others, if the trigger attribute data is associated with an ATVEF trigger, then an STT 200 may receive trigger components in the following format: <URL>[first attribute name: first attribute value] . . . [n^{th} attribute name: n^{th} attribute value] [checksum].

In response to receiving the trigger attribute data, the STT 200 causes an interactive icon having the attribute(s) identified by the trigger attribute data to be displayed via a display device, as indicated in step 302. Then in step 303, the STT 200 receives user input selecting the interactive icon. In response to receiving the user input, the STT 200 provides a television presentation enhancement that is associated with the interactive icon.

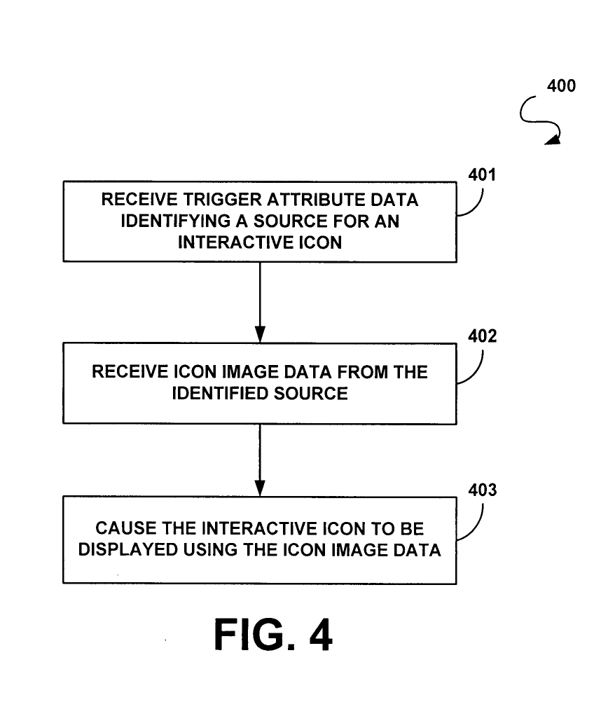

FIG. 4 is a flow chart depicting a method 400 according to one embodiment of the present invention. In step 401, the STT 200 receives trigger attribute data identifying a source for an interactive icon. The source for an interactive icon image may be, for example, a remote server, a local server (e.g., another STT 200), or a local storage device. In response to receiving the trigger attribute data, the STT 200 receives (e.g., downloads or retrieves) icon image data from the identified source, as indicated in step 402, and then causes the interactive icon to be displayed via a display device using the icon image data, as indicated in step 403. The interactive icon image may be downloaded from a remote location using any suitable protocol including for example, among others, http, https, ftp, tftp, bfs, DSM-CC, among others.

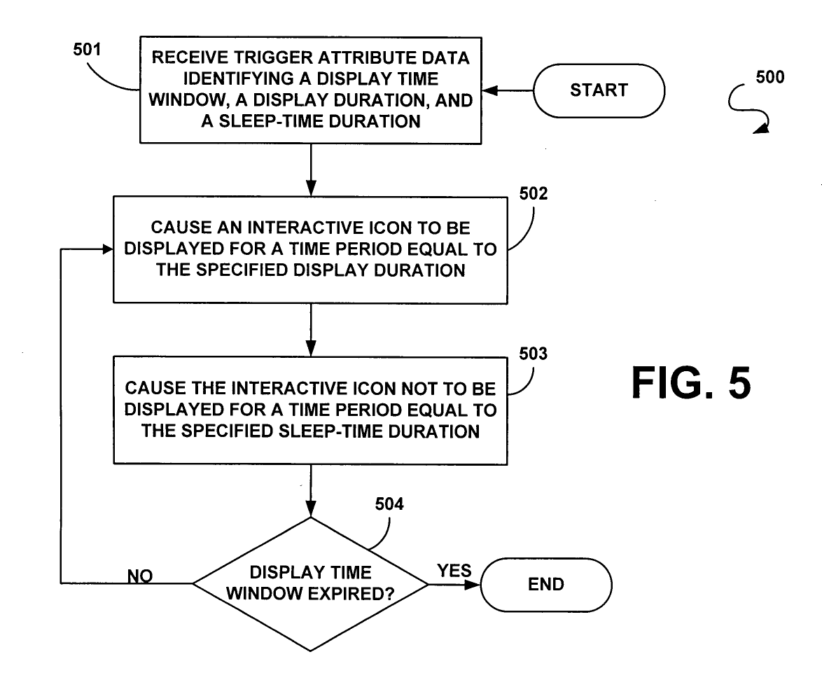

FIG. 5 is a flow chart depicting a method 500 according to one embodiment of the present invention. In step 501, the STT 200 receives trigger attribute data identifying a display time window, a display duration, and a sleep-time duration. In response to receiving the trigger attribute data, the STT 200 causes an interactive icon corresponding to the trigger attribute data to be displayed for a time period equal to the specified display duration, as indicated in step 502. The STT 200 then causes the interactive icon not to be displayed for a time period equal to the specified sleep-time duration, as indicated in step 503. A determination is then made in step 504 as to whether the display time window specified by the trigger attribute data has expired. If the display time window has not expired, then steps 502-504 are repeated until the display time window expires.

The steps depicted in FIGS. 3-5 may be implemented using modules, segments, or portions of code which include one or more instructions. In an alternative implementation, functions or steps depicted in FIGS. 3-5 may be executed out of order from that shown or discussed, including substantially concurrently or in reverse order, depending on the functionality involved, as would be understood by those of ordinary skill in the art.

The functionality provided by the methods illustrated in FIGS. 3-5, can be embodied in any computer-readable medium for use by or in connection with a computer-related system (e.g., an embedded system) or method. In the context of this document, a computer-readable medium is an electronic, magnetic, optical, semiconductor, or other physical device or means that can contain or store a computer program or data for use by or in connection with a computer-related system or method. Furthermore, the functionality provided by the methods illustrated in FIGS. 3-5 can be implemented through hardware (e.g., an application specific integrated circuit (ASIC) and supporting circuitry), software, or a combination of software and hardware.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the preferred embodiments of the invention in logic embodied in hardware and/or software-configured mediums.

1. A method comprising:
receiving from a remote location trigger attribute data identifying at least one display attribute of an interactive icon;
responsive to receiving the trigger attribute data, causing an interactive icon having the at least one attribute identified by the trigger attribute data to be displayed via a display device;
receiving user input selecting the interactive icon; and
responsive to receiving the user input, providing a television presentation enhancement.

2. The method of claim 1, wherein the interactive icon has at least one attribute not identified by the trigger attribute data.

3. The method of claim 1, wherein the trigger attribute data corresponds to a trigger.

4. The method of claim 3, wherein the trigger complies with an ATVEF (Advanced Television Enhancement Forum) standard.

5. The method of claim 1, wherein the remote location is a headend.

6. The method of claim 1, wherein the remote location is a content provider.

7. The method of claim 1, wherein the enhancement comprises an advertisement.

8. The method of claim 1, wherein the enhancement comprises information about a television presentation that was displayed in conjunction with the interactive icon.

9. The method of claim 1, wherein the enhancement comprises data that is received from a source identified by the trigger attribute data.

10. The method of claim 9, wherein the source is accessible via the Internet using a uniform resource locator (URL) that is identified by the trigger attribute data.

11. The method of claim 9, wherein the source is one of an Internet server, a broadcast file system, an object carousel, or a local storage device.

12. The method of claim 9, wherein the enhancement is downloaded using one of a hyper text transfer protocol (http), hyper text transfer protocol secure (https), file transfer protocol (ftp), trivial file transfer protocol (tftp), broadcast file system (bfs), digital storage media command and control (DSM-CC) object carousel.

13. The method of claim 1, wherein the trigger attribute data identifies a display time window during which the interactive icon is to be displayed.

14. The method of claim 13, wherein the interactive icon is displayed responsive to a current time being within the display time window.

15. The method of claim 1, wherein the trigger attribute data identifies a display time duration for displaying the interactive icon.

16. The method of claim 15, wherein the interactive icon is displayed for a time period that is substantially equal to the display time duration.

17. The method of claim 15, wherein the interactive icon is displayed for a plurality of time periods, each of the plurality of time periods being substantially equal to the display time duration.

18. The method of claim 1, wherein the trigger attribute data identifies a sleep time duration for suspending display of the interactive icon.

19. The method of claim 18, wherein display of the interactive icon is suspended for a time period that is substantially equal to the sleep time duration.

20. The method of claim 18, wherein display of the interactive icon is suspended for a plurality of time periods, each of the plurality of time periods being substantially equal to the sleep-time duration.

21. The method of claim 1, wherein the trigger attribute data identifies a screen location for displaying the interactive icon.

22. The method of claim 21, wherein the interactive icon is displayed at the screen location identified by the trigger attribute data.

23. A first set-top terminal (STT) comprising:
logic configured to cause an interactive icon to be displayed via a display device, the interactive icon having at least one display attribute identified by trigger attribute data received from another apparatus; and
logic configured to cause a television presentation enhancement to be displayed via the display device responsive to user input selecting the interactive icon.

24. The STT of claim 23, further comprising memory for storing at least one default value identifying a characteristic of the interactive icon.

25. The STT of claim 23, wherein the trigger attribute data identifies a display time window during which the interactive icon is to be displayed.

26. The STT of claim 25, wherein the interactive icon is displayed responsive to a current time being within the display time window.

27. The STT of claim 23, wherein the trigger attribute data identifies a display time duration for displaying the interactive icon.

28. The STT of claim 27, wherein the interactive icon is displayed for a time period that is substantially equal to the display time duration.

29. The STT of claim 27, wherein the interactive icon is displayed for a plurality of time periods, each of the plurality of time periods being substantially equal to the display time duration.

30. The STT of claim 23, wherein the trigger attribute data identifies a sleep time duration for suspending display of the interactive icon.

31. The STT of claim 30, wherein display of the interactive icon is suspended for a time period that is substantially equal to the sleep time duration.

32. The STT of claim 30, wherein display of the interactive icon is suspended for a plurality of time periods, each of the plurality of time periods being substantially equal to the sleep-time duration.

33. The STT of claim 23, wherein the trigger attribute data identifies a screen location for displaying the interactive icon.

34. The STT of claim 33, wherein the interactive icon is displayed at the screen location identified by the trigger attribute data.

35. The STT of claim 23, wherein the trigger attribute data corresponds to a trigger.

36. The STT of claim 35, wherein the trigger complies with an ATVEF (Advanced Television Enhancement Forum) standard.

37. The STT of claim 23, wherein the other apparatus is a server located at a headend.

38. The STT of claim 23, wherein the other apparatus is a server operated by a content provider.

39. The STT of claim 23, wherein the other apparatus is another STT.

40. The STT of claim 23, wherein the enhancement comprises an advertisement.

41. The STT of claim 23, wherein the enhancement comprises information about a television presentation that was displayed in conjunction with the interactive icon.

42. The STT of claim 23, wherein the enhancement comprises data that is received from a source identified by the trigger attribute data.

43. The STT of claim 42, wherein the source is accessible via the Internet using a uniform resource locator (URL) that is identified by the trigger attribute data.

44. The STT of claim 42, wherein the source is one of an Internet server, a broadcast file system, an object carousel, or a local storage device.

45. The STT of claim 42, wherein the enhancement is downloaded using one of a hyper text transfer protocol (http), hyper text transfer protocol secure (https), file transfer protocol (ftp), trivial file transfer protocol (tftp), broadcast file system (bfs), digital storage media command and control (DSM-CC) object carousel.

46. A method comprising:
receiving from a remote location trigger attribute data identifying at least one display attribute of an interactive icon;
responsive to receiving the trigger attribute data, causing an interactive icon having the at least one attribute identified by the trigger attribute data to be displayed via a display device;
receiving user input selecting the interactive icon; and
responsive to receiving the user input, providing a television presentation enhancement;
wherein the trigger attribute data corresponds to a trigger;
wherein the trigger complies with an ATVEF (Advanced Television Enhancement Forum) standard;
wherein the remote location is a headend, the display device is a television, and the user input is provided by a remote control device;
wherein the enhancement comprises data that is received from a source identified by the trigger attribute data;
wherein the source is accessible via the Internet using a uniform resource locator (URL) that is identified by the trigger attribute data;
wherein the source is one of an Internet server, a broadcast file system, an object carousel, or a local storage device;
wherein the enhancement is downloaded using one of a hyper text transfer protocol (http), a broadcast file system (bfs) protocol, a digital storage media command and control (DSM-CC) protocol, or a file transfer protocol (ftp);
wherein the trigger attribute data identifies a display time window during which the interactive icon is to be displayed;
wherein the interactive icon is displayed responsive to a current time being within the display time window;
wherein the trigger attribute data identifies a display time duration for displaying the interactive icon;
wherein the interactive icon is displayed for a time period that is substantially equal to the display time duration;
wherein the trigger attribute data identifies a sleep time duration for suspending display of the interactive icon;
wherein display of the interactive icon is suspended for a time period that is substantially equal to the sleep time duration;
wherein the trigger attribute data identifies a screen location for displaying the interactive icon;
wherein the interactive icon is displayed at the screen location identified by the trigger attribute data
